(19) United States
(12) Patent Application Publication
(10) Pub. No.: US 2013/0176303 A1
(43) Pub. Date: Jul. 11, 2013

(54) REARRANGING PIXELS OF A THREE-DIMENSIONAL DISPLAY TO REDUCE PSEUDO-STEREOSCOPIC EFFECT

(71) Applicant: Martin Ek, Dalby (SE)

(72) Inventor: Martin Ek, Dalby (SE)

(73) Assignee: SONY ERICSSON MOBILE COMMUNICATIONS AB, Lund (SE)

(21) Appl. No.: 13/823,309

(22) PCT Filed: Mar. 23, 2011
(86) PCT No.: PCT/IB2011/051238

§ 371 Date: Mar. 14, 2013

(51) Int. Cl. G09G 5/14

(52) U.S. Cl. CPC G09G 5/14
USPC 345/419

(57) ABSTRACT

A device may include sensors for obtaining tracking information associated with a user, a display including pixels for displaying images, and an optical guide including optical elements, each of the optical elements blocking or directing light rays from one or more of the pixels. Additionally, the device may include one or more processors to select first right-eye image pixels and first left-eye image pixels from the pixels, send a right-eye image and a left-eye image via the first right-eye image pixels and the first left-eye image pixels, respectively, determine a relative location of the user based on the tracking information obtained by the sensors, select second right-eye image pixels and second-left-eye image pixels from the pixels based on the tracking information, display the right-eye image via the second right-eye image pixels, and display the left-eye image via the second left-eye image pixels.

### BACKGROUND

A three-dimensional (3D) display may provide a stereoscopic effect (e.g., an illusion of depth) by rendering two slightly different images, one image for the right eye (e.g., a right-eye image) and the other image for the left eye (e.g., a left-eye image) of a viewer. When each of the eyes sees its respective image on the display, the viewer may perceive a stereoscopic image.

### SUMMARY

According to one aspect, a method may include displaying a stereoscopic image on a display that includes first right-eye image pixels and first left-eye image pixels, wherein the first right-eye image pixels display a right-eye image of the stereoscopic image and the first left-eye image pixels display a left-eye image of the stereoscopic image. The method may also include determining a position of a user relative to a display of a device to obtain position information, wherein the device includes the display and an optical guide, and wherein the optical guide includes optical elements for directing light rays from the pixels. Furthermore, the method may include selecting second right-eye image pixels and second left-eye image pixels based on the position of the user, displaying the right-eye image via the second right-eye image pixels, displaying the left-eye image via the second left-eye image pixels, and transmitting the right-eye image and the left-eye image from the second right-eye image pixels and the second left-eye image pixels to the user.

Additionally, selecting the second right-eye image pixels and second left-eye image pixels may include displaying the right-eye image via the first right-eye image pixels and the first left-eye image pixels, respectively.

Additionally, selecting the second right-eye image pixels and second left-eye image pixels may include selecting the first-right eye image pixels as the second left-eye image pixels, and selecting the first left-eye image pixels as the second right-eye image pixels.

Additionally, selecting the second right-eye image pixels and second left-eye image pixels may include selecting pixels to display images that are vertically and horizontally translated versions of the right-eye image and left-eye image.

Additionally, the optical guide may include a parallax barrier element layer; a prism element layer; a grating element layer; or a lenticular lens element layer.

Additionally, the right eye image may be as same as the left eye image when the user position is not on a sweet spot, to convey a two-dimensional image to the user.

Additionally, the method may further include directing the right-eye image to the right-eye of the user during a first time interval, and directing the left-eye image to the left-eye of the user during a second time interval following the first time interval.

Additionally, the method may further include: receiving a user selection of a predefined location associated with receiving the stereoscopic image.

Additionally, the method may further include determining a second position of a second user relative to the display to obtain second position information, displaying a second stereoscopic image via the display concurrently with the stereoscopic image, and controlling the optical elements to send light rays from third right-eye image pixels and third left-eye image pixels to convey the second stereoscopic image to the second position of the second user.

Additionally, the method may further include determining values for control variables that are associated with the optical elements to change relative power associated with the stereoscopic image in relation to power associated with a pseudo-stereoscopic image at the position of the user.

Additionally, determining the values may include looking up a table of values of the control variables, wherein the values are pre-computed based on ratios of the power associated with the stereoscopic image to the power associated with the pseudo-stereoscopic image.

According to another aspect, a device may include sensors for obtaining tracking information associated with a user, a display including pixels for displaying images, and an optical guide including optical elements, each of the optical elements blocking or directing light rays from one or more of the pixels. The device may also include one or more processors to select first right-eye image pixels and first left-eye image pixels from the pixels, and send a right-eye image and a left-eye image via the first right-eye image pixels and the first left-eye image pixels, respectively. Additionally, the one or more processors may be further configured to determine a relative location of the user based on the tracking information obtained by the sensors, select second right-eye image pixels and second-left-eye image pixels from the pixels based on the tracking information, display the right-eye image via the second right-eye image pixels, and display the left-eye image via the second left-eye image pixels.

Additionally, the sensors may include at least one of a gyroscope; a camera; a proximity sensor; or an accelerometer.

Additionally, the device may include a tablet computer; a cellular phone; a personal computer; a laptop computer; a camera; or a gaming console.

Additionally, the optical elements may include at least one of a parallax barrier element layer; a lenticular lens element layer; a prism element layer; or a grating element layer.

Additionally, when selecting the second right-eye image pixels and second left-eye image pixels, the one or more processors may be configured to select both the first right-eye image pixels and the first left-eye image pixels to display the right-eye image.

Additionally, when selecting the second right-eye image pixels and second left-eye image pixels, the one or more processors may be configured to select the first right-eye image pixels as the second left-eye image pixels, and select the first left-eye image pixels as the second right-eye image pixels.

Additionally, when selecting the second right-eye image pixels and second left-eye image pixels, the one or more processors may be configured to select pixels that are horizontally and vertically shifted version of the first right-eye image pixels.

Additionally, the right eye image may be as same as the left-eye image when the user position is not on a sweet spot, for the device to convey a two-dimensional image to the user.

According to yet another aspect, a device may include sensors for providing tracking information associated with a user, a display including pixels, and parallax barrier elements for allowing or blocking light rays from one or more of the pixels to reach a right eye or a left eye of a user. Furthermore, the device may include one or more processors to select first right-eye image pixels and first left-eye image pixels from the pixels, send a right-eye image and a left-eye image via the first right-eye image pixels and the first left-eye image pixels, respectively, determine a relative location of the user based on the tracking information, select second right-eye image pixels and second-left-eye image pixels based on the tracking information, display the right-eye image via the second right-eye image pixels, and display the left-eye image via the second left-eye image pixels.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1A is a diagram of an exemplary three-dimensional (3D) system in which concepts described herein may be implemented;

FIG. 1B illustrates generation of a pseudo-stereoscopic image in the system of FIG. 1A;

FIGS. 2A and 3B are front and rear views of one implementation of an exemplary device of FIG. 1A;

FIG. 3 is a block diagram of components of the exemplary device of FIG. 1A;

FIG. 4 is a block diagram of exemplary functional components of the device of FIG. 1A;

FIGS. 5A and 5B illustrate exemplary operation of the device of FIG. 1A according to one implementation;

FIG. 6A illustrates exemplary operation of the device of FIG. 1A according to another implementation;

FIG. 6B illustrates exemplary operation of the device of FIG. 1A according to yet another implementation; and

FIG. 7 is a flow diagram of an exemplary process for eliminating pseudo-stereoscopic images by the device of FIG. 1A.

### DETAILED DESCRIPTION

The following detailed description refers to the accompanying drawings. The same reference numbers in different drawings may identify the same or similar elements. In addition, the terms “viewer” and “user” are used interchangeably.

### Overview

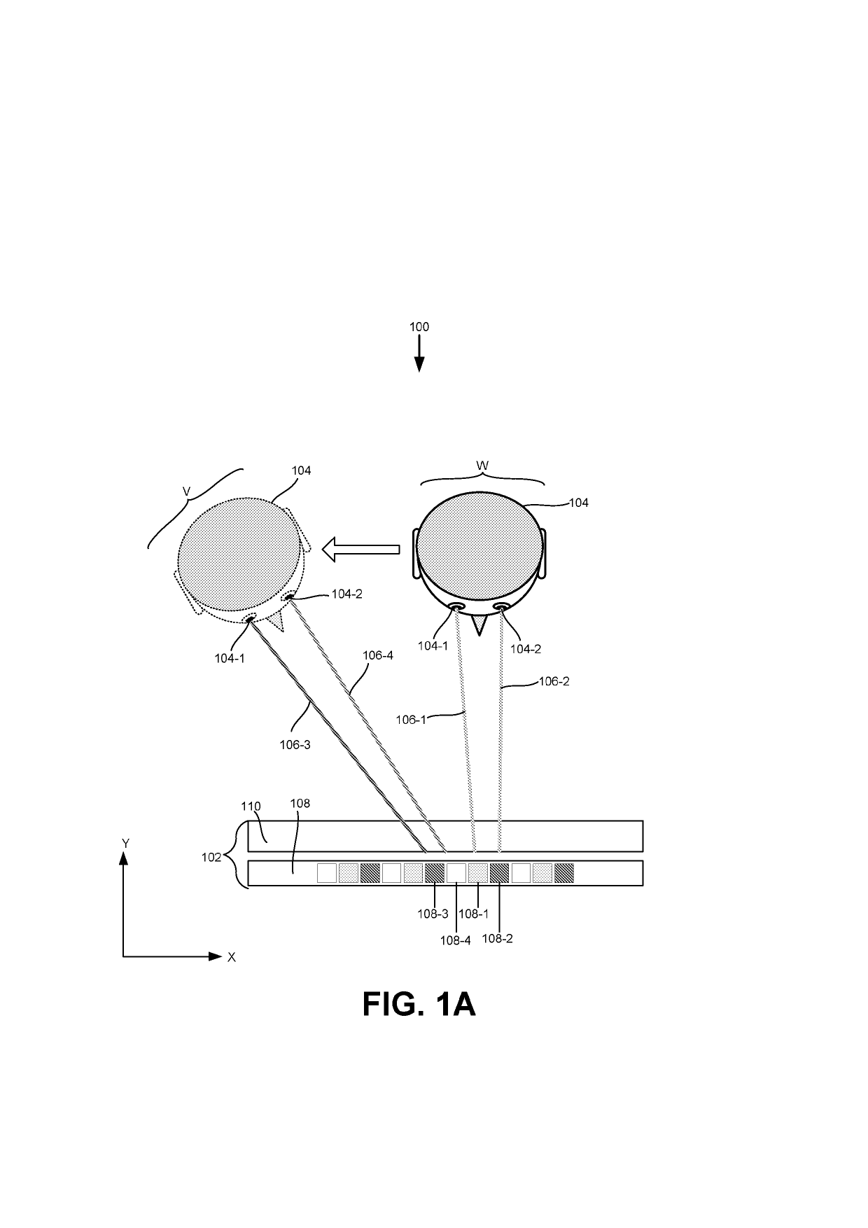

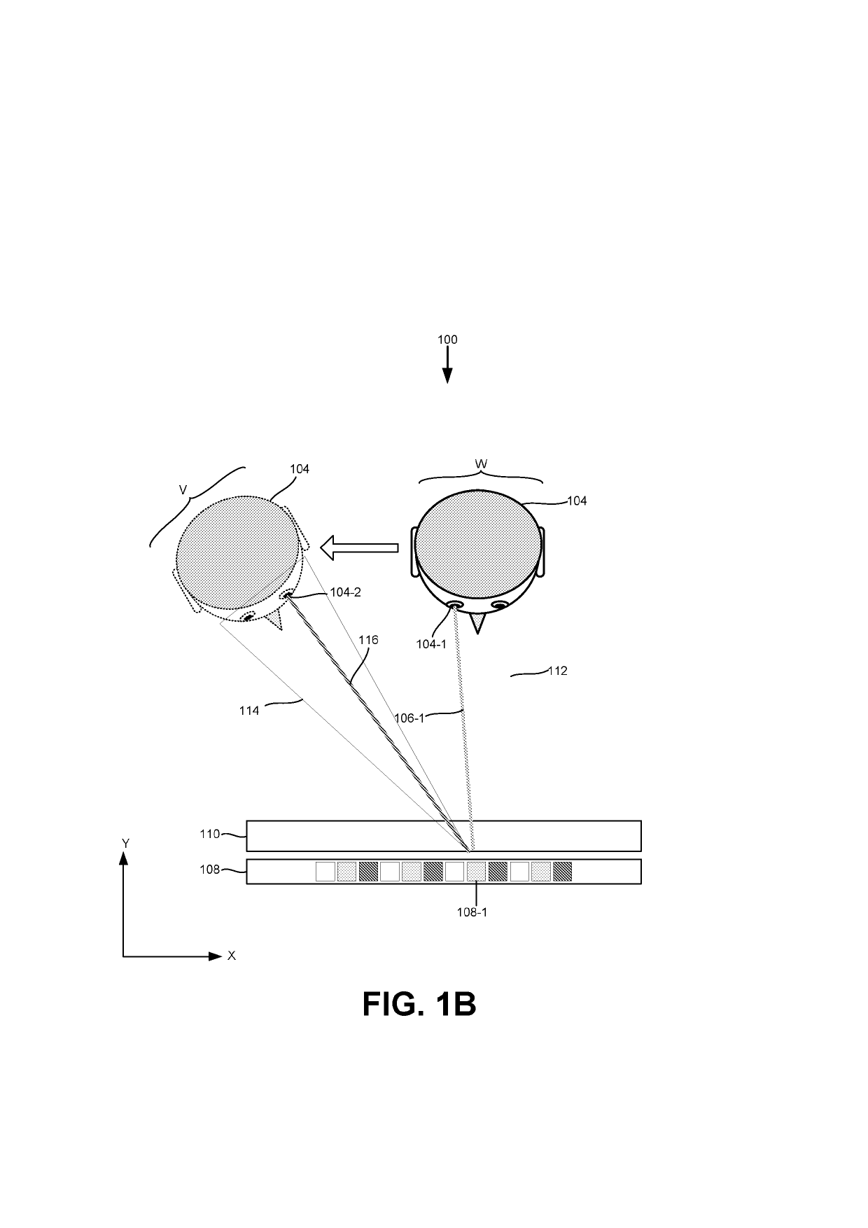

Aspects described herein provide a visual three-dimensional (3D) effect based on device tracking, viewer tracking, and rearranging pixels of a 3D display. As further described below, the pixels may be rearranged in different ways. FIG. 1A is a diagram of an exemplary 3D system 100 in which concepts described herein may be implemented. As shown, 3D system 100 may include a device 102 and a viewer 104. Device 102 may generate and provide two-dimensional (2D) or 3D images to viewer 104 via a display. When device 102 shows a 3D image, the right eye 104-1 and the left-eye 104-2 of viewer 104 may receive a right-eye image and a left-eye image via light rays 106-1 and 106-2 that emanate from device 102. Light rays 106-1 and 106-2 may carry different visual information, such that, together, they provide a stereoscopic image to viewer 104.

Device 102 may include a display 108 and optical guide 110. Display 108 may include picture elements (pixels) for displaying images for right eye 104-1 and left eye 104-2. In FIG. 1A, pixels 108-1 and 108-3 are part of right-eye images and pixels 108-2 and 108-4 are part of left-eye images. Optical guide 110 directs light rays from right-eye image pixels to right eye 104-1 and left-eye image pixels to left eye 104-2. As described below, optical guide 110 may include multiple layers of optical elements.

In FIG. 1A, device 102 may not radiate or transmit the left-eye image and the right-eye image in an isotropic manner. Accordingly, at certain locations, viewer 104 may receive the best-quality stereoscopic image that device 102 is capable of conveying. As used herein, the term “sweet spots” may refer to locations at which viewer 104 can perceive relatively high quality stereoscopic images. When viewer 104 is at location W, viewer 104 is on one of the sweet spots. At other locations, viewer 104 may receive incoherent images. As used herein, the term “pseudo-stereoscopic image” may refer to the incoherent images or low quality images.

In FIG. 1A, viewer 104's position or location relative to device 102 may change. For example, as shown, viewer 104 may change from position W to position V. The change in the relative position may result from viewer 104's movement (e.g., translation, rotation, etc.) or from device 102's movement (e.g., translation, rotation, etc.).

In FIG. 1A, when viewer 104 moves from W to V, display 108 and/or optical guide 110 may change their configurations, for device 102 to continue to send light rays to right eye 104-1 and left eye 104-2 from corresponding right-eye and left-eye images, respectively, on display 108, such that viewer 104 continues to perceive 3D images. That is, when viewer 104 moves to V, display 108 and/or optical guide may change their configuration to shift or move the sweet spot to location V. Because the location of sweet spot depends on the location of optical guide and locations of its constituent components relative to the pixels of display 108 (i.e., geometry of the components of optical guide 110 and the pixels), device 102 may move the sweet spots by moving or reconfiguring optical guide 110 and/or by rearranging pixels. As used herein, the term “pixel” refers to a portion of digital image, which is represented by a corresponding addressable component on display 108 (which is also called “pixel”). Accordingly, the phrase “rearranging pixel” may refer to moving the portion of a digital image on display (e.g., shifting an image, rotating an image, and/or performing other image-related operations).

For example, when viewer 104 moves from position W to position V, device 102 may reconfigure optical guide 110 (e.g., changes the control variables associated with optical guide 110 and/or control variables associated with outputting an image on display 108). Accordingly, optical guide 110 guides light rays 106-3 and 106-4 from pixels 108-3 and 108-4 to right eye 104-1 and left eye 104-2, respectively.

In another example, when viewer 104 moves from position W to position V, by rearranging pixels on display 108, device 102 may prevent light rays from inappropriate or wrong image pixels on display 108 from reaching right eye 104-1 and left eye 104-2. The light rays from the inappropriate image pixels may result in viewer 104's perception of a pseudo-stereoscopic image. This may interfere with viewer's perception of high quality 3D images.

FIG. 1B illustrates generation of a pseudo-stereoscopic image in 3D system 100. In FIG. 1B, when viewer 104 moves from W to V, viewer 104 may receive, on left eye 104-2, light rays (e.g., light ray 116) from right-eye image pixels (e.g., pixel 108-1). Similarly, although not shown, viewer 104 may receive, on right eye 104-1, light rays from left-eye image pixels. This may result in viewer 104 perceiving a pseudo-stereoscopic image.

In implementations described herein, device 102 may send appropriate right-eye and left eye images to right eye 104-1 and left eye 104-2, respectively, and eliminate or decrease the power associated with pseudo-stereoscopic image(s), by adjusting pixels of display 108 and/or controlling optical guide 110. Device 102 may perform these functions based on viewer 104 tracking and device 102 tracking

### Exemplary Device

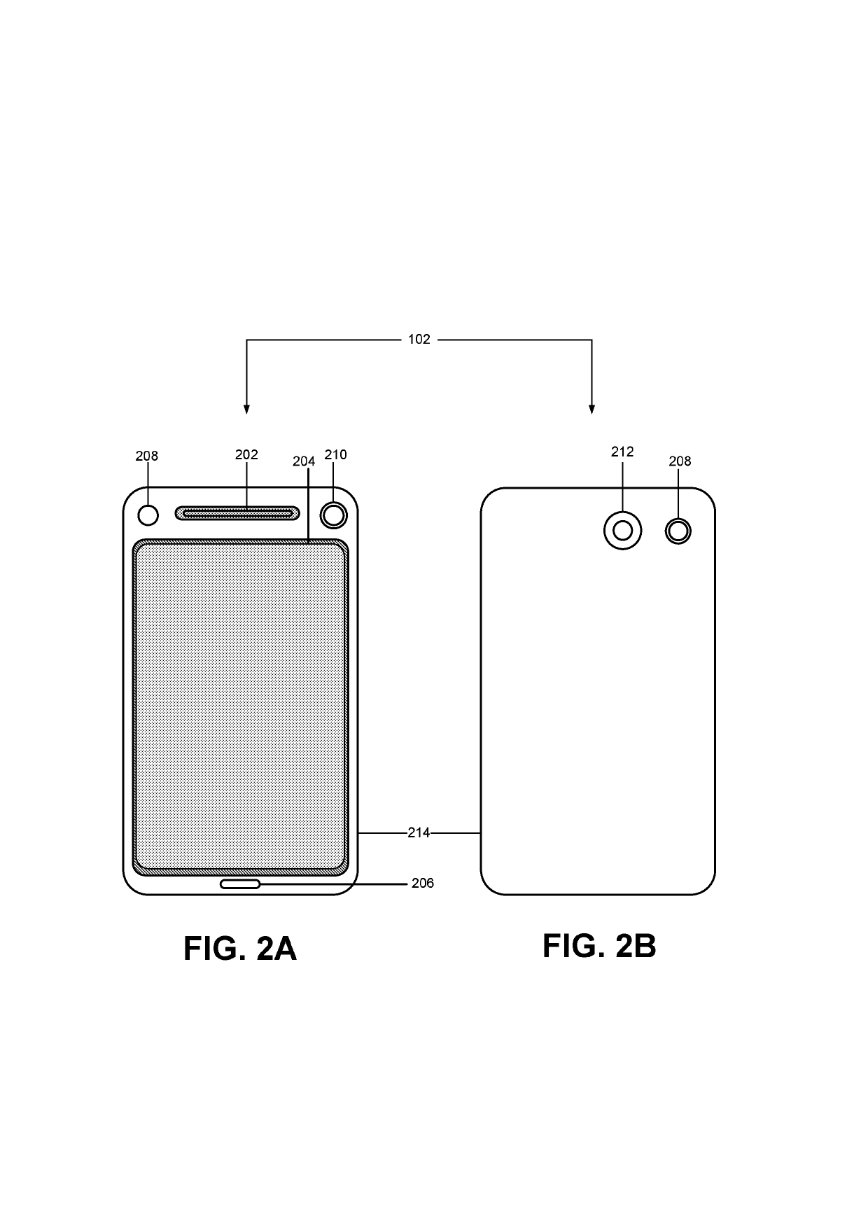

FIGS. 2A and 2B are front and rear views of one implementation of device 102.

Device 102 may include any of the following devices that have the ability to or are adapted to display 2D and 3D images, such as a cell phone or a mobile telephone with a 3D display (e.g., smart phone); a tablet computer; an electronic notepad, a gaming console, a laptop, and/or a personal computer with a 3D display; a personal digital assistant (PDA) that can include a 3D display; a peripheral (e.g., wireless headphone, wireless display, etc.); a digital camera; or another type of computational or communication device with a 3D display, etc.

As shown in FIGS. 2A and 2B, device 102 may include a speaker 202, a 3D display 204, a microphone 206, sensors 208, a front camera 210, a rear camera 212, and housing 214. Speaker 202 may provide audible information to a user/viewer of device 102.

3D display 204 may provide two-dimensional or three-dimensional visual information to the user. Examples of 3D display 204 may include an auto-stereoscopic 3D display, a stereoscopic 3D display, a volumetric display, etc. 3D display 204 may include pixels that emit different light rays to viewer 104's right eye 104-1 and left eye 104-2 , through optical guide 110 (FIGS. 1A and 1B) (e.g., a lenticular lens, a parallax barrier, etc.) that covers the surface of 3D display 204. Each pixel may include sub-pixels, such as a red, green, or blue, or green (RBG) sub-pixels. In one implementation, optical guide 110 may dynamically change the directions in which the light rays are emitted from the surface of display 204, depending on input from device 102. In some implementations, 3D display 204 may also include a touch-screen, for receiving user input.

Microphone 206 may receive audible information from the user. Sensors 208 may collect and provide, to device 102, information pertaining to device 102 (e.g., movement, orientation, etc.), information that is used to aid viewer 104 in capturing images (e.g., for providing information for auto-focusing to front/rear cameras 210/212) and/or information tracking viewer 104 (e.g., proximity sensor). For example, sensor 208 may provide acceleration and orientation of device 102 to internal processors. In another example, sensors 208 may provide the distance and the direction of viewer 104 relative to device 102, so that device 102 can determine how to control optical guide 110. Examples of sensors 208 include an accelerometer, gyroscope, ultrasound sensor, an infrared sensor, a camera sensor, a heat sensor/detector, etc.

Front camera 210 and rear camera 212 may enable a user to view, capture, store, and process images of a subject located at the front/back of device 102. Front camera 210 may be separate from rear camera 212 that is located on the back of device 102. In some implementations, device 102 may include yet another camera at either the front or the back of device 102, to provide a pair of 3D cameras on either the front or the back. Housing 214 may provide a casing for components of device 102 and may protect the components from outside elements.

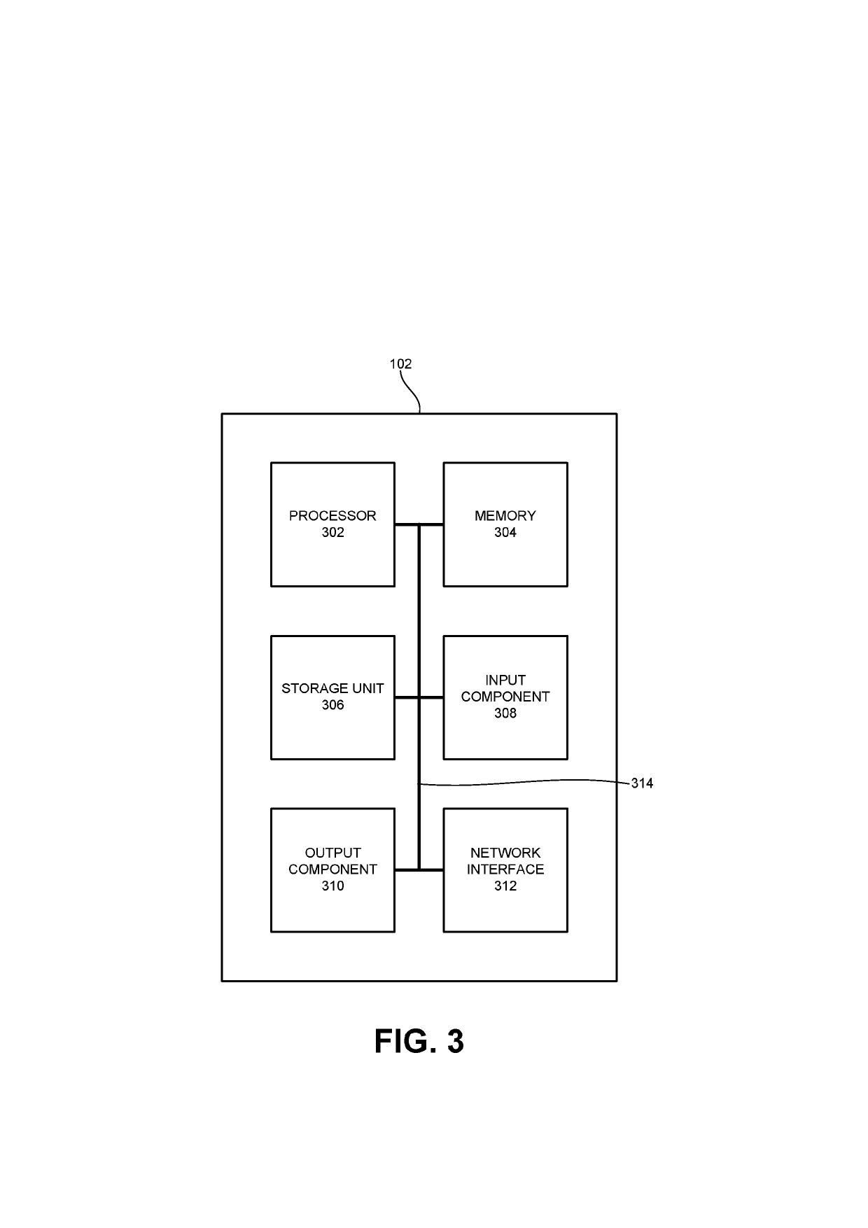

FIG. 3 is a block diagram of device 102. As shown, device 102 may include a processor 302, a memory 304, storage unit 306, input component 308, output component 310, a network interface 312, and a communication path 314. In different implementations, device 102 may include additional, fewer, or different components than the ones illustrated in FIG. 3.

Processor 302 may include a processor, a microprocessor, an Application Specific Integrated Circuit (ASIC), a Field Programmable Gate Array (FPGA), and/or other processing logic capable of controlling device 102. In one implementation, processor 302 may include components that are specifically designed to process images (e.g., 3D images and 2D images). For example, processor 302 may be able to quickly shift an image on display 108 in either horizontal or vertical direction on the surface of display

Memory 304 may include static memory, such as read only memory (ROM), and/or dynamic memory, such as random access memory (RAM), or onboard cache, for storing data and machine-readable instructions. In some implementations, memory 304 may also include display/video memory/RAM for displaying and/or manipulating images. In these implementations, a region of display may be mapped to a portion the display RAM.

Accordingly, manipulation of images on display 108 (e.g., shifting an image) may entail moving contents of the memory in the display RAM. For example, shifting an image on display 108 by 1 pixel may include shifting contents of the video RAM (e.g., copy an image in video RAM at memory locations 1 through 99 to locations 2 through 100).

Storage unit 306 may include a magnetic and/or optical storage/recording medium. In some embodiments, storage unit 306 may be mounted under a directory tree or may be mapped to a drive. Depending on the context, the term “medium,” “memory,” “storage,” “storage device,” “storage medium,” and/or “storage unit” may be used interchangeably. For example, a “computer-readable storage device” or “computer readable storage medium” may refer to both a memory and/or storage device.

Input component 308 may permit a user to input information to device 102. Input component 308 may include, for example, a keyboard, a keypad, a mouse, a pen, a microphone, a touch screen, voice recognition and/or biometric mechanisms, sensors, etc. Output component 310 may output information to the user. Output component 310 may include, for example, a display, a printer, a speaker, etc.

Network interface 312 may include a transceiver that enables device 102 to communicate with other devices and/or systems. For example, network interface 312 may include mechanisms for communicating via a network, such as the Internet, a terrestrial wireless network (e.g., a WLAN), a satellite-based network, a personal area network (PAN), a WPAN, etc. Additionally or alternatively, network interface 312 may include a modem, an

Ethernet interface to a LAN, and/or an interface/connection for connecting device 102 to other devices (e.g., a Bluetooth interface).

Communication path 314 may provide an interface through which components of device 102 can communicate with one another.

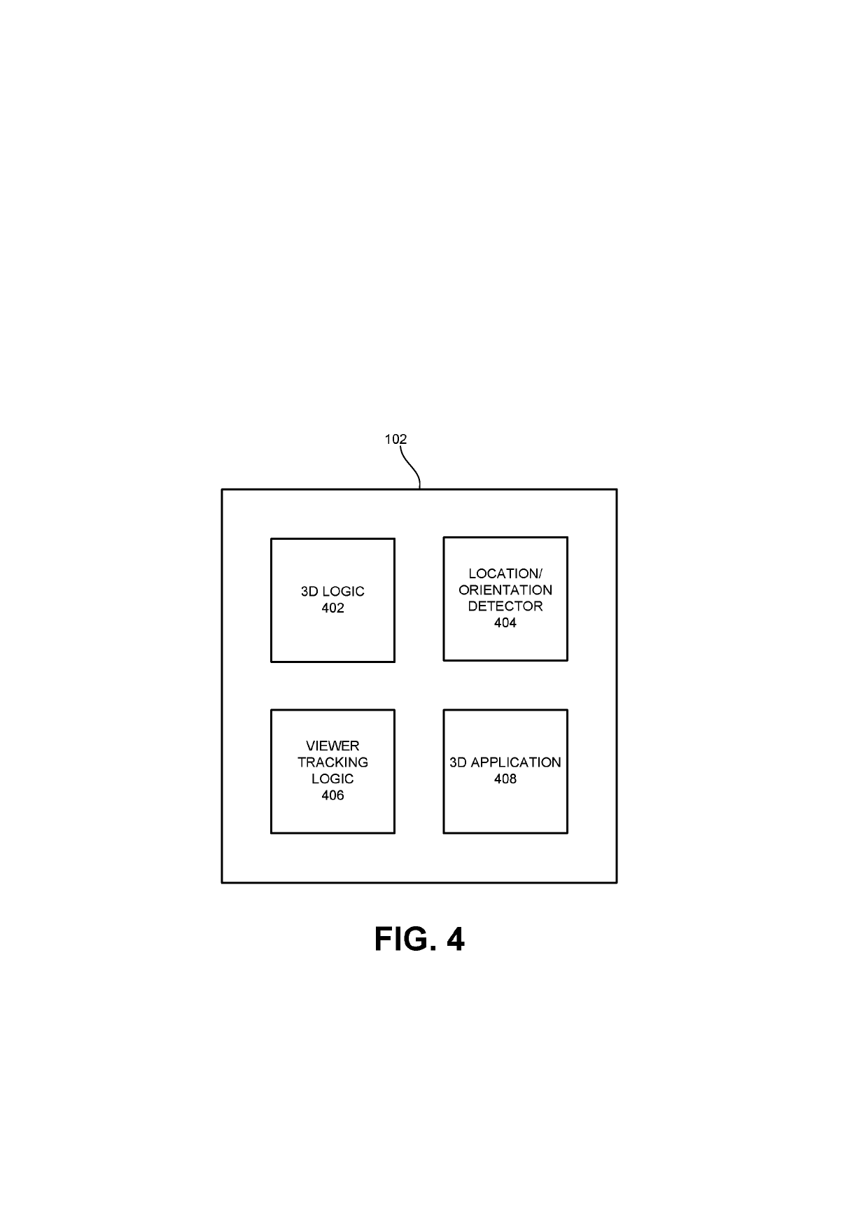

FIG. 4 is a functional block diagram of device 102. As shown, device 102 may include 3D logic 402, location/orientation detector 404, viewer tracking logic 406, and 3D application 408. Although not illustrated in FIG. 4, device 102 may include additional functional components, such as the components that are shown in FIG. 4, an operating system (e.g., Windows Mobile OS, Blackberry OS, Linux, Android, iOS, Windows Phone, etc.), an application (e.g., an instant messenger client, an email client, etc.), etc.

3D logic 402 may include hardware and/or software components for obtaining right-eye images and left-eye images and/or providing the right/left-eye images to a 3D display (e.g., display 204). In obtaining the right-eye and left-eye images, 3D logic 402 may receive right- and left-eye images from stored media content (e.g., a 3D movie). Furthermore, 3D logic 402 may perform certain functions that are associated with 3D rendering, such as image translation, pixel rearrangement, controlling optical guide 110, etc. For example, 3D logic 402 may include display driver circuit that is able to shift pixels in display 108 by one or more columns. In other implementations, 3D logic 402 may generate the right and left-eye images of a 3D model or object for different pixels or sub-pixels. In such instances, device 102 may obtain projections of the 3D object onto 3D display 108.

Once 3D logic 402 has obtained a right-eye image and a left-eye image, 3D logic 402 may control the display of 3D images on display 108 by controlling a display driver circuit or a display driver (e.g., cause device 102 to shift a left-eye image, right-eye image, or both by one or more pixels). For example, 3D logic 402 may cause the display driver to shift the left-eye image and right-eye image on display 108 by one or more pixels, in order to change the locations of sweet spots. In another example, 3D logic 402 may cause the display driver to swap the right-eye image shown by the right-eye image pixels with the left-eye image shown by the left-eye image pixels. This may also move the locations of sweet spots.

In yet another example, 3D logic 402 may cause both the right-eye image pixels and left-eye image pixels to show either the right-eye image or the left-eye image. This may cause display 108 to show 2D images instead of 3D images. However, this may eliminate pseudo-stereoscopic effects, and therefore allow viewer 104 to perceive coherent 2D images. In some implementations, 3D logic 402 may receive viewer input for selecting a sweet spot. In one implementation, when a viewer selects a sweet spot (e.g., by pressing a button on device 102), device 102 may store values of control variables that characterize optical guide 110, the location/orientation of user device 102, and/or the relative location of viewer 104. In another implementation, when the user selects a sweet spot, device 102 may recalibrate optical guide 110 such that the stereoscopic images are sent to the selected spot. In either case, as the viewer's relative location moves away from the established sweet spot, 3D logic 402 may determine (e.g., calculate) new directions to which light rays must be guided via optical guide 110 and control pixels on display 108 in accordance with the computed values.

In some implementations, the orientation of device 102 may affect the relative location of sweet spots. Accordingly, making proper adjustments to the angles at which the light rays from device 102 are directed, via optical guide 110, may be used in locking the sweet spot for viewer 104. The adjustments may be useful, for example, when device 102 is relatively unstable (e.g., being held by a hand). As described below, depending on the implementation, 3D logic 402 may make different types of adjustments to optical guide 110.

Returning to FIG. 4, location/orientation detector 404 may determine the location/orientation of device 102 and provide location/orientation information to 3D logic 402, viewer tracking logic 406, and/or 3D application 408. In one implementation, location/orientation detector 404 may obtain the information from a Global Positioning System (GPS) receiver, gyroscope, accelerometer, etc. in device 102.

Viewer tracking logic 406 may include hardware and/or software (e.g., a range finder, proximity sensor, cameras, image detector, etc.) for tracking viewer 104 and/or part of viewer 104 (e.g., head, eyes, the distance from display 204, the distance between the viewer 104's eyes, etc.) and providing the location/position of viewer 104 (or viewer 104's eyes) to 3D logic 402. In some implementations, viewer tracking logic 406 may include sensors (e.g., sensors 208) and/or logic for determining a location of viewer 104's head or eyes based on sensor inputs (e.g., distance information from sensors, an image of a face, an image of eyes 104-1 and 104-2 from cameras, etc.).

3D application 408 may include hardware and/or software that show 3D images on display 108. In showing the 3D images, 3D application 408 may use 3D logic 402, location/ orientation detector 404, and/or viewer tracking logic 406 to generate 3D images and/or provide the 3D images to display 108. Examples of 3D application 408 may include a 3D graphics game, a 3D movie player, etc.

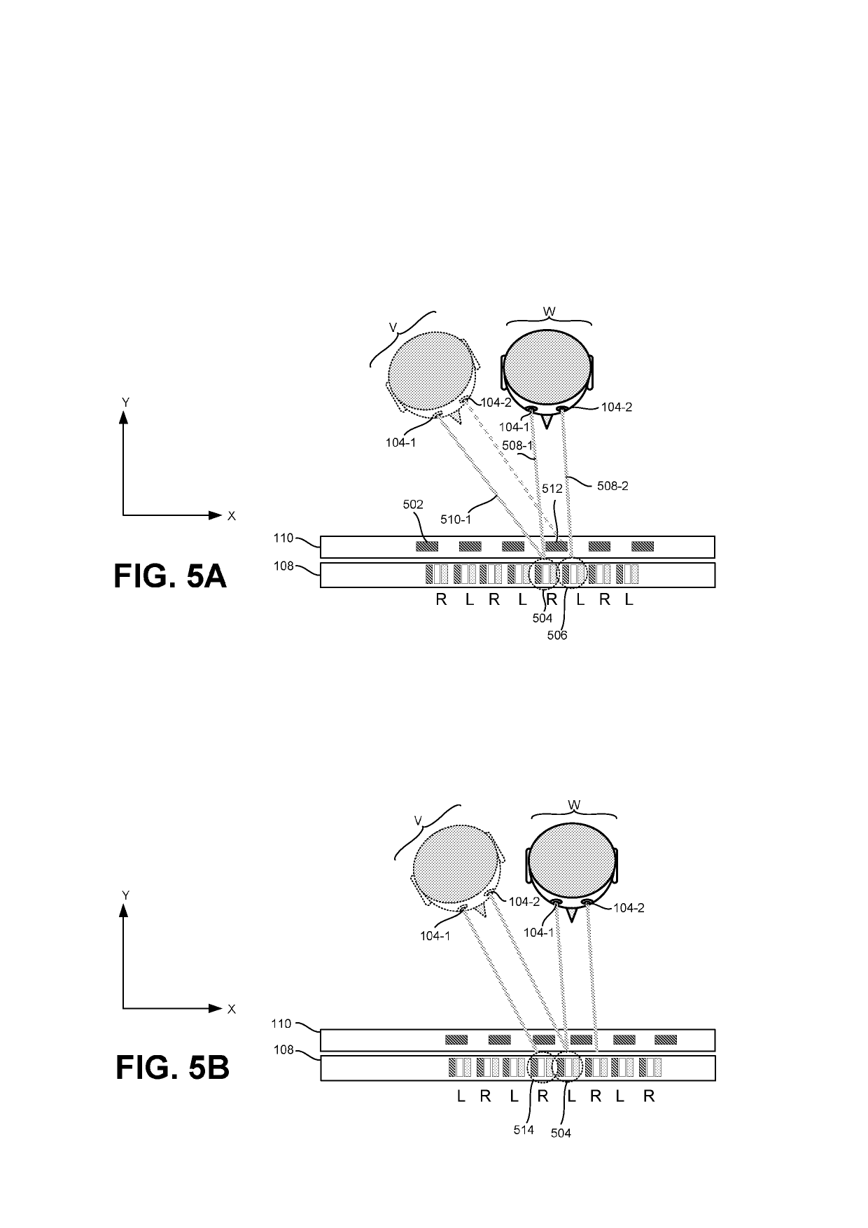

FIGS. 5A and 5B illustrate exemplary operation of device 102 according to one embodiment. FIG. 5A shows optical guide 110 and display 108. In FIG. 5A, optical guide 110 is shown as a parallax barrier. As further shown, optical guide 110 may include optical elements, one of which is shown as parallax barrier element 502. As shown, display 108 may include groups of pixels, which are labeled as L, R, L, R, etc. “L” denotes left-eye image pixel, and “R” denotes a right image pixel. As further shown, each pixel may include sub-pixels (e.g., red, green, or blue sub-pixels).

In FIG. 5A, right-eye image pixel 504 sends light rays 508-1 from a right-eye image and left-eye image pixel 506 sends light rays 508-2 from a left-eye image. In addition, optical guide 110 guides light rays 508-1 to right eye 104-1 and light rays 508-2 to left eye 104-2 of viewer 104 at location W. When viewer 104 moves to location V, however, viewer 104 may no longer lie on one of the sweet spots provided via display 108 and optical guide 110.

In FIG. 5A, when viewer 104 moves to location V, due to optical element 504 of optical guide 110, left eye 104-2 of viewer 104 is no longer able to receive light rays from a left eye image pixel 506. That is, optical element 512 blocks light from left image pixel 506 from reaching left eye 104-2. Although optical elements separate right-eye images from left eye images at the sweet spots, at other locations of viewer 104, the optical elements may prevent eyes 104-1 and 104-2 from receiving their corresponding light rays to obtain stereoscopic images. Furthermore, the geometry and/or optical properties of the optical elements may be such that pseudo-stereoscopic images form at viewer 104 location V.

To allow right and left eyes 104-1 and 104-2 of viewer 104 at location V to receive their corresponding images, device 102 may change which pixels transmit which portion of the left-eye image and the right-eye image. By rearranging which pixels are part of a right-eye image and left-eye image, device 102 may modify the locations of the pixels (portions of a digital image) relative to optical elements in optical guide 110, and hence, change the locations of the sweet spots.

FIG. 5B shows rearranging pixels on display 108 according to one implementation. In this implementation, device 102 switches the roles of right-eye image pixels and left-eye image pixels to shift or move sweet spots. In FIG. 5B, when viewer 104 moves from location W to location V, device 102 causes pixels that displayed right-eye images (i.e., right-eye image pixels) and pixels that displayed left-eye images (i.e., left-eye image pixels) to display left-eye images and right eye images, respectively. In effect, device 102 reverses the roles of left-eye image pixels and right-eye image pixels. As shown in FIG. 5B, due to the rearrangement, pixel 514 and pixel 504 become right-eye image pixel and left-eye image pixel, respectively, to form a portion of the stereoscopic image that was formed by the former right-eye image pixel 504 and left-eye image pixel 506. Left-eye image pixel 504 and right-eye image pixel 514 emit light rays that reach left-eye 104-2 and right eye 104-1 of viewer 104 at location V, respectively.

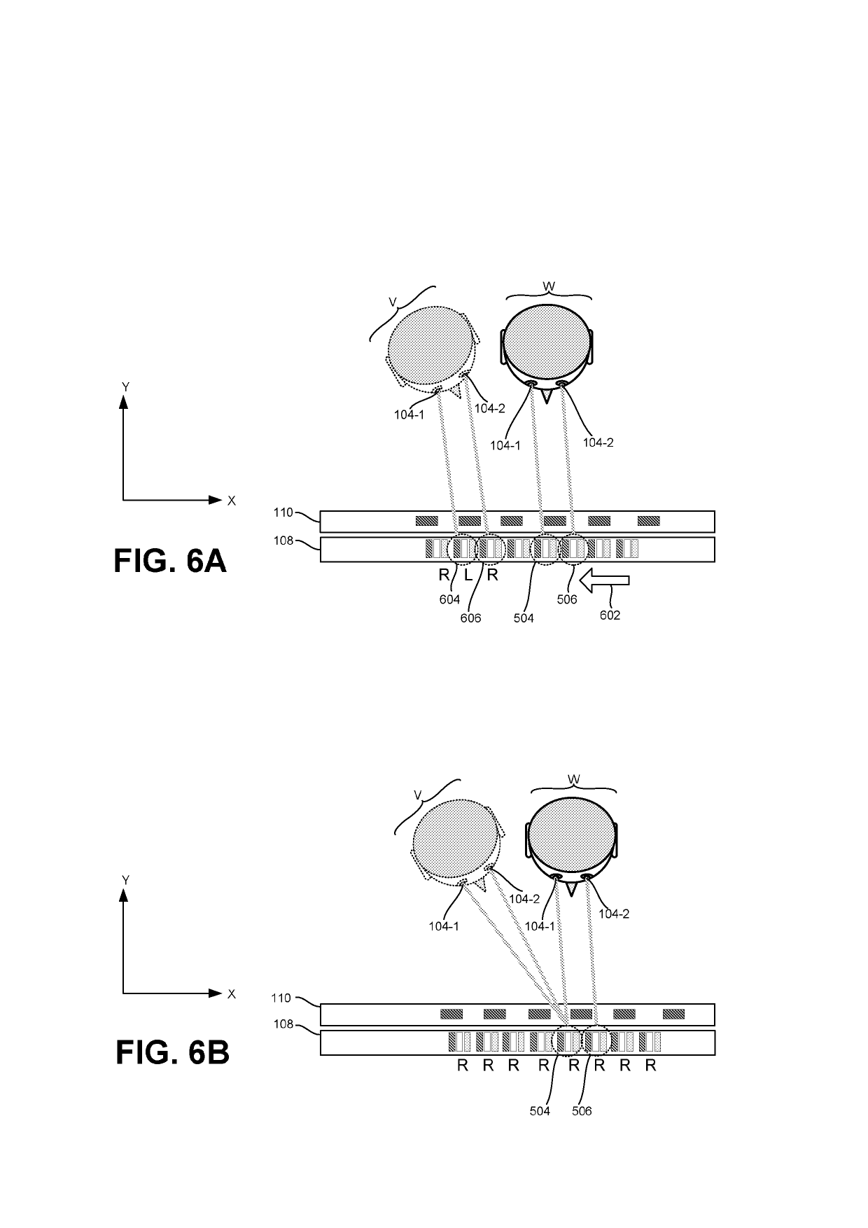

FIG. 6A shows rearranging pixels on display 108 according to another implementation. In this implementation, device 102 shifts an image that is shown by display 108 by one or more pixels in horizontal or vertical direction relative to optical guide 110, to move the sweet spots. In FIG. 6A, when viewer moves from location W to location V, device 102 shifts the right-eye image and the left-eye images displayed by the pixels of display 108 in the direction of arrow 602. For example, due to the shift, pixels 604 and 606 become new left-eye image pixel and right-eye image pixel, respectively, that form a portion of the stereoscopic image that was formed by the former right-eye and left-eye image pixels 504 and 506. The light rays from right-eye image pixel 604 and left-eye image pixel 606 reach right eye 104-1 and left eye 104-2 of viewer 104 unobstructed by the optical elements in optical guide 110.

FIG. 6B shows rearranging pixels of display 108 according to yet another implementation. In this implementation, device 102 either replaces a right-eye image with a left-eye image, or alternatively, replaces a left-eye image with a right eye image. This removes any pseudo-stereoscopic images. At the same time, this also removes the stereoscopic effect, and turns the original 3D image shown on display 108 into a 2D image.

In FIG. 6B, when viewer 104 moves from location W to location V, device 102 may cause the left-eye image pixels to show the right-eye image, and leave the right-eye image pixels intact. Alternatively, when viewer 104 moves from location W to location V, device 102 may cause right-eye image pixels to show the left-eye image, and leave left-eye image pixels intact. These rearrangements result in display 108 converting a 3D image to a 2D image and showing the 2D image. As shown in FIG. 6B, as the result or rearranging the pixels, the pixels of display 108 show only right-eye image. The light rays from right-eye image pixel 504 reach right eye 104-1 and left eye 104-2 of viewer 104 unobstructed by the optical elements.

### Exemplary Process for Eliminating Pseudo-Stereoscopic Images Based on Viewer/Device Tracking

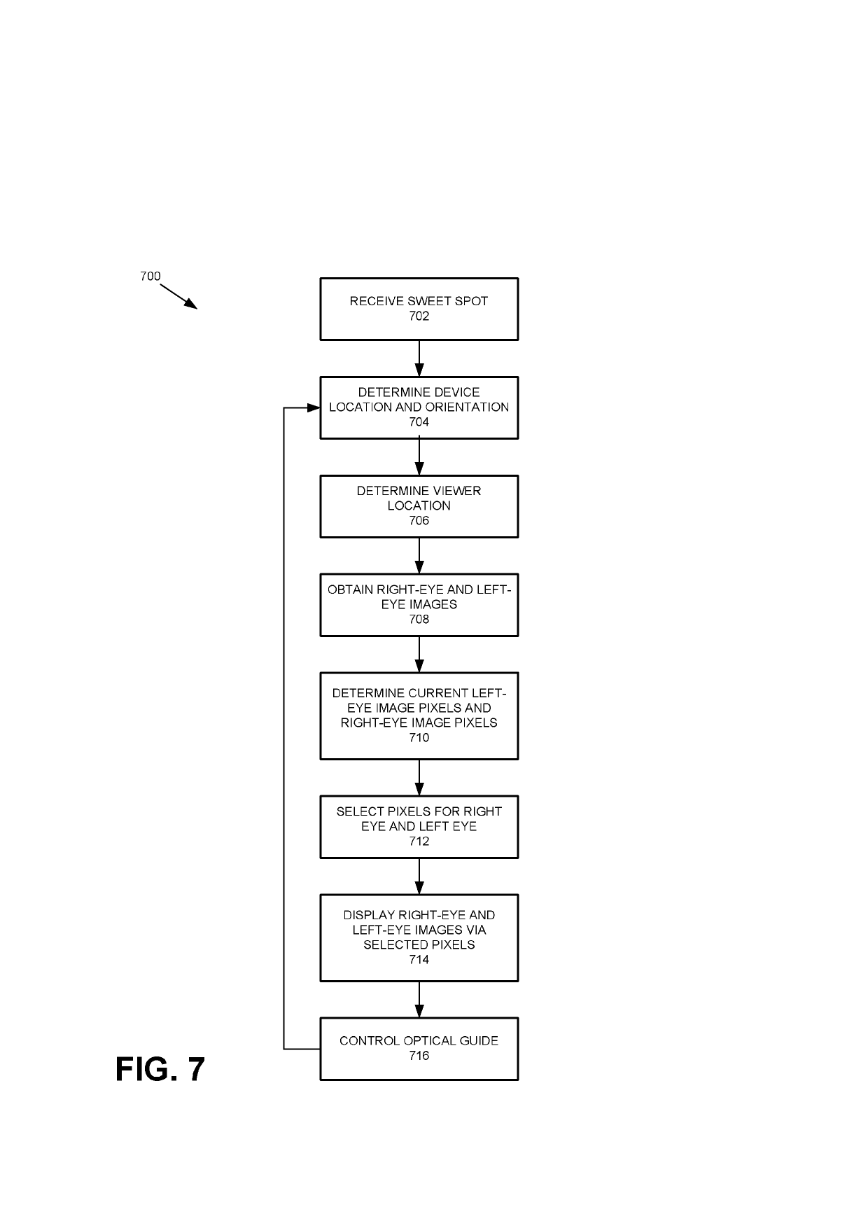

FIG. 7 is a flow diagram of an exemplary process 700 for eliminating pseudo-stereoscopic images by device 102, based on tracking device 102 and/or viewer 104. Assume that 3D logic 402 and/or 3D application 408 is executing on device 102. Process 700 may include receiving a viewer input for selecting a sweet spot (block 702). For example, viewer 104 may indicate that viewer 104 is in a sweet spot by pressing a button on device 102, touching a soft switch on display 204 of device 102, etc. In response to the viewer input, 3D logic 402/3D application 408 may store the values of control variables (e.g., angles at which optical guide 110 or the optical elements are sending light rays from pixels, the location/orientation of device 102, the relative location of viewer 104 or part of viewer 104's body (e.g., viewer 104's head, viewer 104's eyes, etc.), identities of pixels that are sending images to the right eye and of pixels that are sending images to the left eye, etc.). In some implementations, block 702 may be omitted, as sweet spots for device 102 may be pre-configured.

Device 102 may determine device 102's location and/or orientation (block 704). In one implementation, device 102 may obtain its location and orientation from location/orientation detector 404 (e.g., information from GPS receiver, gyroscope, accelerometer, etc.).

Device 102 may determine viewer 104's location (block 706). Depending on the implementation, device 102 may determine viewer 104 location in one of several ways. For example, in one implementation, device 102 may use a proximity sensor (e.g., sensors 208) to locate viewer 104 (e.g., distance from the viewer's eyes to device 102/display 108 and an angle (e.g., measured normal to display 108). In another implementation, device 102 may sample images of viewer 104 (e.g., via camera 210 or 212) and perform object detection (e.g., to locate the viewer's eyes, to determine the distance between the eyes, to recognize the face, to determine tilt of the viewer's head, etc.). Such information may be used to determine stereoscopic images and pseudo-stereoscopic images (projected from display 108) at right eye 104-1 and left eye 104-2 of viewer 104.

Device 102 may obtain right-eye and left-eye images (block 708). For example, in one implementation, 3D application 408 may obtain right-eye and left-eye images from a media stream from a content provider over a network. In another implementation, 3D application 408 may generate the images from a 3D model or object based on viewer 104's relative location from display 108 or device 102.

Device 102 may determine pixels, on display 108, that are configured to convey right-eye images to right eye 104-1 (i.e., right-eye image pixels) and pixels, on display 108, that are configured to convey left-eye images to left eye 104-2 (i.e., left-eye image pixels) (block 708). Depending on the implementation, the left- and right-eye image pixels may already be set, or alternatively, device 102 may dynamically determine the right-eye image pixels and left-eye image pixels.

Device 102 may select pixels for right eye and left-eye images based on viewer 104 and device 102 tracking (block 712). When device 102 determines that viewer 104 is not on a sweet spot, as discussed above with reference to FIGS. 5A, 5B, 6A, and 6B, device 102 may eliminate pseudo-stereoscopic images by performing one of the following; selecting currently right-eye image pixels to display a left-eye image and selecting currently left-eye image pixels to display a right-eye image and thus reversing the roles of left-eye image pixels and right-eye image pixels (FIG. 5B); shifting the image in horizontal or vertical direction in the plane of display 108; (FIG. 6A); and selecting both left-eye image pixels and right-eye image pixels to display one image (e.g., a right-eye image or a left-eye image) (FIG. 6B). Device 102 may determine whether one of these pixel rearrangements may provide for a best 3D or 2D image to viewer 104, and select the right-eye image and left-eye image pixels accordingly. Furthermore, device 102 may cause the right-eye image and the left-eye image to be displayed by the selected right- and left-eye pixels (block 714).

In some implementations, device 102 may determine values for control variables for optical elements in optical guide 110, based on viewer 104 tracking (e.g., tracking viewer 104's eyes, head, etc.) and device 102 tracking, to dynamically configure optical guide 110. Setting the control variables may control the optical properties (e.g., the index of refraction, the curvature of lens, etc.), physical properties (e.g., locations of optical elements relative to display), etc. In these implementations, when the rearrangement of pixels cannot provide sweet spots to viewer 104 and cannot eliminate pseudo-stereoscopic effect to a sufficient degree, device 102 may control optical guide 110 (or optical elements of optical guide 110, such as optical element 502) to direct or guide light rays from display 108, aiding device 102 in moving the sweet spots.

Device 102 may display right-eye and left-eye images on the selected pixels (block 714). Furthermore, device 102 may control optical guide 110 to send light rays from the pixels to viewer 104 (block 716), to aid display 108 in shifting the sweet spots. Depending on the implementation, optical guide 110 may include parallax guide elements, lenticular lens elements, prism elements, grating elements, etc. As described above, device 102 may control each element of optical guide 110 independently of other components, or, alternatively, as a group/unit, to guide the light rays. Controlling each element of optical guide 110 may include modifying the values of control variables that are associated with optical guide or elements.

Each determined values of the control variables may reflect, for viewer 104, strength or power of stereoscopic image relative to that of pseudo-stereoscopic image. For example, in some implementations, device 102 may change the control variables to obtain a particular ratio (e.g., a value greater than a threshold) of the stereoscopic image power to pseudo-stereoscopic image power (e.g., a maximum value).

Depending on the implementation, 3D logic 402 may use different approaches to determine the values of control variables for the layers of optical elements. In some implementations, 3D logic 402 may access a function whose evaluation entails operation of a hardware component, execution of a software program, or look up of a table. In one implementation, the function may accept viewer 104's relative location and may output the values of the control variables based on calculated ratio of power of the stereoscopic image to power of the pseudo-stereoscopic image.

When the function is implemented as a table, 3D logic 402 may look up the control values (i.e., values of the control variables) based on viewer's location relative to display 108. Evaluating the function can be fast, since the values of the table are pre-computed (e.g., based on ratios of power contributed via an optical element in forming a stereoscopic image to power contributed via the optical element in forming pseudo-stereoscopic images).

In some implementations, device 102 may time multiplex left-eye images and right-eye images via the same set of pixels. (e.g. send a right-eye image to a set of pixels for a brief interval and send a left-eye image to the same set of pixels for the following interval). In these implementations, device 102 may control the optical elements, to send a right-eye image from display 108 to right-eye 104-1 when the right-eye image is on display 108 and to send a left eye-image from display 108 to left-eye 104-2 when the left-eye image is on display 108. Processing may continue in this manner, with device 102 changing the optical characteristics of the optical elements as the user moves or as device 102 moves relative to viewer 104.

In some implementations, the number of viewers that device 102 can support with respect to displaying 3D images may be greater than one (i.e., more than one viewer can see 3D images on display 108 at the same time). In such instances, some pixels may send images for the right eye of a first viewer, some pixels may send images to the left eye of the first viewer, some pixels may send images to the right eye of a second viewer, etc. Each optical element may guide light rays from each pixel to the right of left eye of a particular viewer based on location information associated with the viewers.

In other implementations, at least some of the pixels may multiplex images for multiple viewers. Device 102 may control the optical elements (i.e., change the control values), such that the optical elements guide light rays from each image on display 108 to a particular viewer/eyes.

### Conclusion

The foregoing description of implementations provides illustration, but is not intended to be exhaustive or to limit the implementations to the precise form disclosed. Modifications and variations are possible in light of the above teachings or may be acquired from practice of the teachings.

For example, device 102 may change some of optical properties of optical guide 110 via micro-electromechanical (MEMS) components. In other implementations, device 102 may modify the optical properties (e.g., index of refraction) of optical elements via other types of components, such as muscle wires, memory alloys (e.g., alloys that change shape and return to the shape), piezoelectric components (e.g., actuators), controllable polymers, etc. In still some implementations, individual elements of optical guide 110 may be independently controlled. In other implementations, optical guide 110 may include multiple layers of optical elements.

In the above, while a series of blocks has been described with regard to exemplary processes 700 illustrated in FIG. 7, the order of the blocks in processes 700 may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
displaying a stereoscopic image on a display that includes first right-eye image pixels and first left-eye image pixels, wherein the first right-eye image pixels display a right-eye image of the stereoscopic image and the first left-eye image pixels display a left-eye image of the stereoscopic image;
determining a position of a user relative to a display of a device to obtain position information, wherein the device includes the display and an optical guide, and wherein the optical guide includes optical elements for directing light rays from the pixels;
selecting second right-eye image pixels and second left-eye image pixels based on the position of the user;
displaying the right-eye image via the second right-eye image pixels;
displaying the left-eye image via the second left-eye image pixels; and
transmitting the right-eye image and the left-eye image from the second right-eye image pixels and the second left-eye image pixels to the user.

2. The method of claim 1, wherein selecting the second right-eye image pixels and second left-eye image pixels includes:
displaying the right-eye image via the first right-eye image pixels and the first left-eye image pixels, respectively.

3. The method of claim 1, wherein selecting the second right-eye image pixels and second left-eye image pixels includes:
selecting the first-right eye image pixels as the second left-eye image pixels; and
selecting the first left-eye image pixels as the second right-eye image pixels.

4. The method of claim 1, wherein selecting the second right-eye image pixels and second left-eye image pixels includes:
selecting pixels to display images that are vertically and horizontally translated versions of the right-eye image and left-eye image.

5. The method f claim 1, wherein the optical guide includes:
a parallax barrier element layer; a prism element layer; a grating element layer; or a lenticular lens element layer.

6. The method of claim 1, wherein the right eye image is as same as the left eye image when the user position is not on a sweet spot, to convey a two-dimensional image to the user.

7. The method of claim 1, further comprising:
directing the right-eye image to the right-eye of the user during a first time interval; and
directing the left-eye image to the left-eye of the user during a second time interval following the first time interval.

8. The method of claim 1, further comprising:
receiving a user selection of a predefined location associated with receiving the stereoscopic image.

9. The method of claim 1, further comprising:
determining a second position of a second user relative to the display to obtain second position information;
displaying a second stereoscopic image via the display concurrently with the stereoscopic image; and
controlling the optical elements to send light rays from third right-eye image pixels and third left-eye image pixels to convey the second stereoscopic image to the second position of the second user.

10. The method of claim 1, further comprising:
determining values for control variables that are associated with the optical elements to change relative power associated with the stereoscopic image in relation to power associated with a pseudo-stereoscopic image at the position of the user.

11. The method of claim 10, wherein determining the values includes:
looking up a table of values of the control variables, wherein the values are pre-computed based on ratios of the power associated with the stereoscopic image to the power associated with the pseudo-stereoscopic image.

12. A device comprising:
sensors for obtaining tracking information associated with a user;
a display including pixels for displaying images;
an optical guide including optical elements, each of the optical elements blocking or directing light rays from one or more of the pixels; and
one or more processors to:
select first right-eye image pixels and first left-eye image pixels from the pixels;
send a right-eye image and a left-eye image via the first right-eye image pixels and the first left-eye image pixels, respectively;
determine a relative location of the user based on the tracking information obtained by the sensors;
select second right-eye image pixels and second-left-eye image pixels from the pixels based on the tracking information;
display the right-eye image via the second right-eye image pixels; and
display the left-eye image via the second left-eye image pixels.

13. The device of claim 12, wherein the sensors include at least one of:
a gyroscope; a camera; a proximity sensor; or an accelerometer.

14. The device of claim 12, wherein the device includes:
a tablet computer; a cellular phone; a personal computer; a laptop computer; a camera; or a gaming console.

15. The device of claim 12, wherein the optical elements include at least one of:
a parallax barrier element layer; a lenticular lens element layer; a prism element layer; or a grating element layer.

16. The device of claim 12, wherein when selecting the second right-eye image pixels and second left-eye image pixels, the one or more processors are configured to:
select both the first right-eye image pixels and the first left-eye image pixels to display the right-eye image.

17. The device of claim 12, wherein when selecting the second right-eye image pixels and second left-eye image pixels, the one or more processors are configured to:
select the first right-eye image pixels as the second left-eye image pixels; and
select the first left-eye image pixels as the second right-eye image pixels.

18. The device of claim 12, wherein when selecting the second right-eye image pixels and second left-eye image pixels, the one or more processors are configured to:
select pixels that are horizontally and vertically shifted version of the first right-eye image pixels.

19. The device of claim 12, wherein the right eye image is as same as the left-eye image when the user position is not on a sweet spot, for the device to convey a two-dimensional image to the user.

20. A device comprising:
sensors for providing tracking information associated with a user;
a display including pixels;
parallax barrier elements for allowing or blocking light rays from one or more of the pixels to reach a right eye or a left eye of a user;
one or more processors to:
select first right-eye image pixels and first left-eye image pixels from the pixels;
send a right-eye image and a left-eye image via the first right-eye image pixels and the first left-eye image pixels, respectively;
determine a relative location of the user based on the tracking information;
select second right-eye image pixels and second-left-eye image pixels based on the tracking information;
display the right-eye image via the second right-eye image pixels; and
display the left-eye image via the second left-eye image pixels.
